(19) United States
(12) Patent Application Publication
(10) Pub. No.: US 2004/0162722 A1
(43) Pub. Date: Aug. 19, 2004

(54) Speech quality indication

(76) Inventors: James Alexander Rex, Hampshire (GB); David John Benjamin Pearce, Hampshire (GB)

Correspondence Address: MOTOROLA, INC., 1303 EAST ALGONQUIN ROAD, IL01/3RD, SCHAUMBURG, IL, 60196

(21) Appl. No.: 10/478,222

(22) PCT Filed: May 21, 2002
(86) PCT No.: PCT/EP02/05606

(30) Foreign Application Priority Data
May 22, 2001 (GB) 0112439.5

(51) Int. Cl. G10L 19/14

(52) U.S. Cl. 704/211

(57) ABSTRACT

A voice communications device (4) and speech processing method are described. A speech signal, generated by a microphone (41) in response to speech input (2) in to the microphone (41) by a user (1), has a proportion extracted therefrom. The speech signal is transmitted to an appliction apparatus that may be integral or remote. A speech quality value is evaluated for the extracted speech signal. An indication of the quality of the speech signal, based on the speech quality value, is indicated to the user. Thus a direct indication of the current quality of a received speech signal, in a form that is easily interpreted by a non-expert user of the device, is provided, thereby providing the use with an opportunity to improve the sppech quality. Examples of appliction apparatus include hands-free telephones and automatic speech recognition systems.

### FIELD OF THE INVENTION

This invention relates to devices and systems in which speech is input by a user. This includes, but is not limited to, hands-free telephones and automatic speech recognition systems.

### BACKGROUND OF THE INVENTION

When speech sounds are received by a device, the received speech signal may be of poor quality due to the presence of noise and/or speech distortion. Noise or distortion may originate acoustically, or may be introduced in the speech-reception electronics. Acoustic noise and speech echoes are particularly problematic when the speech-reception microphone is relatively distant from the speaker's mouth. It is well known that poor speech signal quality is annoying for human listeners, and greatly degrades the performance of speech recognisers. Nevertheless, many new personal communications and computing devices use (or will use) speech input from a microphone that is remote from the speaker.

It is often possible to improve the received speech quality by making adjustments to the speaker's acoustic environment, or to the speech-reception device. Potential acoustic adjustments include muting noise sources, speaking more clearly, pointing the microphone at the speaker's mouth, or moving it closer to the mouth. Potential electronic adjustments include changing the microphone pre-amplifier's gain, or re-positioning the antennas used in a wireless microphone system. However, in conventional arrangements, the user is not able to gauge what adjustment is required.

One simple way of monitoring received speech quality is to listen to the speech, via a loudspeaker. However, when the speech sound is heard directly as well as from a feedback source, the two sounds are mixed, and it becomes difficult to assess the quality of the received speech. This inevitably occurs when the speaker simultaneously listens to his/her own received speech via a loudspeaker (e.g. in a public address system or the sidetone in a telephone handset). Hearing-impaired people find it particularly difficult to assess the received quality of their speech in this way.

When good speech reception quality is essential, such as in professional audio recording, someone other than the speaker (e.g. a sound engineer) is conventionally employed to monitor the received speech and adjust its quality. This person avoids hearing the speaker directly, usually by using headphones to hear the received speech. However, this approach is not possible when the speaker himself/herself is the only person in control of the speech-reception device.

If the received speech signal is transmitted immediately to a remote person, that person may give some indication of poor speech quality, such as requesting that words are repeated. Some automatic speech recognisers can give similar indirect indications of poor speech quality. In such cases, however, it is often not clear whether the poor quality is due to the speech reception device, or to some other device it is connected to. For example, noise or distortion may be introduced by a telecommunications link, or a speech recogniser may not understand the speaker's pronunciation, or an unusual word may have been spoken. Hence, despite such indirect indications, the user will often not be aware when his/her speech-reception device is receiving poor quality speech.

Even when the user is aware that the received speech quality needs improvement, indirect or intermittent indications of speech quality are not well suited to helping the user make adjustments that improve speech quality.

Some sound-reception devices indicate the current level of the received signal (using a VU meter, for example). However, this does not distinguish between speech and noise, or reveal speech distortion. Some sound-reception devices display the current input power spectrum, but it requires considerable expertise to infer speech quality from a spectral display.

Meters are available that measure the level of the speech component of a noisy speech signal. However, this is test equipment for use by experts. This equipment is not adapted to indicate the quality level of the speech signal in ordinary use, at the same time as the speech signal is being employed in an end-use device or system. So these specialized test devices have no real-time influence on the performance or use of an end-use device. A user of an end-use device does not, for example, use such a test device to judge how far from a noise source to stand, in order to produce an acceptable speech/noise signal.

Signal-processing algorithms are available that evaluate the quality of a noisy or distorted speech signal. Again, these are used by experts, and again are not adapted to indicate the quality level of the speech signal at the same time the speech signal is being employed in an end-use device or system.

Prior art documents U.S. Pat. No. 6,016,136, U.S. Pat. No. 5,949,886, U.S. Pat. No. 5,684,921, JP-A-11-01194794 and JP-A-09044183 are known to the applicant.

### STATEMENT OF INVENTION

In a first aspect, the present invention provides a voice communications device, as claimed in claim 1. In a second aspect, the present invention provides a method of processing speech, as claimed in claim 17. Further aspects are as claimed in the dependent claims.

The invention enables the user of a device to make real-time adjustments that improve speech quality. These adjustments may relate, for example, to the proximity of the user to a microphone or a noise source.

### BRIEF DESCRIPTION OF THE DRAWINGS

Embodiments of the present invention will be described, by way of example only, with reference to the accompanying drawings, in which:

FIG. 1 is a schematic illustration of a voice communications device for receiving speech from a user and indicating the quality of the resulting speech signal to the user in an embodiment of the invention;

FIG. 2 is a schematic illustration of a voice communications device for receiving speech from a user and indicating the quality of the resulting speech signal to the user in another embodiment of the invention; and

FIG. 3 is a flowchart showing process steps employed in an embodiment of the invention.

### DESCRIPTION OF PREFERRED EMBODIMENTS

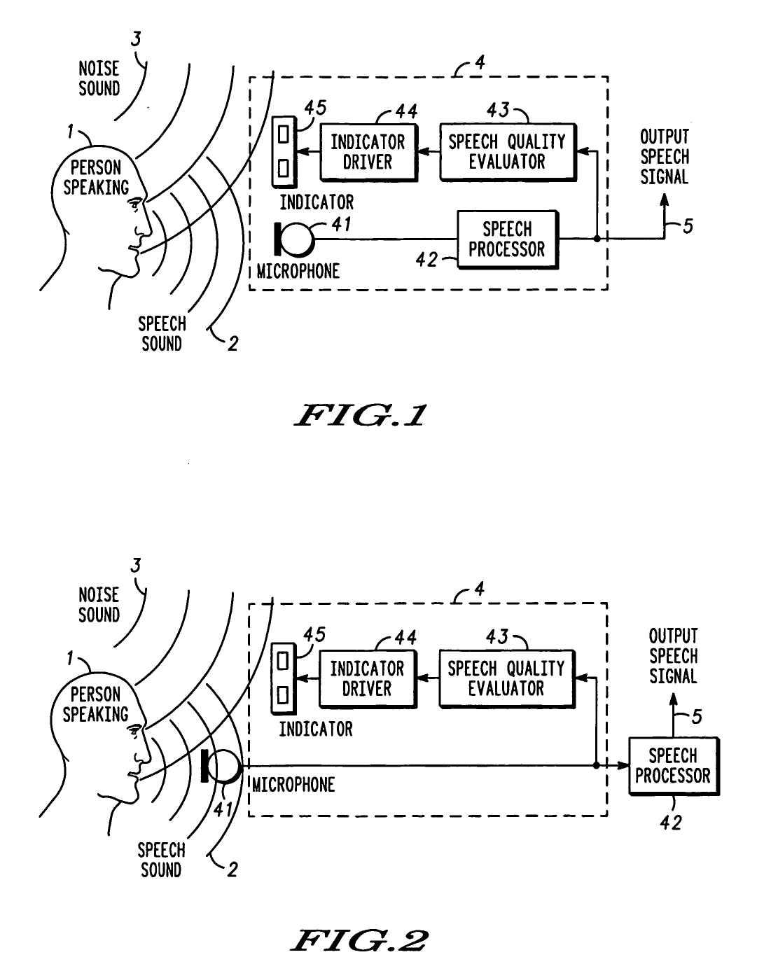

Referring to FIG. 1, in a first embodiment, the invention is embodied as a voice communications device (4) that receives speech sound (2) from a person speaking (1) and transmits its received speech signal (5) onward as an output speech signal to an end-use device (i.e. application apparatus). A microphone 41 transduces into a speech signal both the speech sound (2), and any noise sound (3) that is present.

In this embodiment, this speech signal is then converted by a speech processor (42) into a received speech signal (5), whose format is suitable for onward transmission.

As well as being transmitted onward, the received speech signal (5) is fed to a speech quality evaluator (43). The speech quality evaluator extracts a proportion of the signal. The speech quality evaluator (43) quantifies the signal's speech quality. The resultant speech quality measure is fed to an indicator driver (44), which generates an appropriate indication of the currently received speech quality. This indication is made apparent to the user of the voice communications device (4) by an indicator (45).

The user may adjust the voice communications device (4), the microphone 41, or other aspects of the local environment so as to change the received speech quality. The user is immediately able to determine the effect of such adjustments on speech quality, by monitoring the speech quality indicator (45).

The speech processor (42) could include various components, such as amplifiers, filters, analogue-to-digital conversion, speech coding and/or decoding, transmission over a local communications link, or parameterisation by a speech recogniser's front end. Some components of the speech processor (42) may add noise or distortion to the received speech signal (5).

It is preferable that the user should be able to make adjustments that reduce any significant noise or distortion introduced in the speech processor (42). Otherwise, the utility of the speech quality indication is reduced. Any component whose noise or distortion cannot be adjusted by the user is preferably placed further along the signal chain, beyond the point at which the speech quality evaluator (43) is connected.

The speech quality evaluator (43) may quantify speech quality in various ways. Two simple examples of speech quality measures which may be employed are (i) the speech signal level (ii) the speech signal to noise ratio (SNR). Other speech quality measures, which correlate more closely to perceived speech quality, are known to the skilled person and may be employed when appropriate.

The speech quality indication generated by the indicator driver (44) may have various precisions. It may be a binary indication (e.g. GOOD/NOT GOOD), or it may indicate a wide range of speech quality values. Generally, the quality level may be indicated discretely or as a continual value.

The speech quality indicator (45) may take various forms.

A visual indicator may be employed for devices positioned some distance in front of the user. Examples are:

(i) a warning light that is lit when speech quality is poor (i.e. below an acceptable threshold level), and

(ii) a colour bargraph display, as used in many signal level meters. In this embodiment such a bargraph display is used, as shown for indicator 45 in FIG. 1. Depending on the type of indicator used, a corresponding indicator driver may be required, and implemented in conventional fashion. Such an indicator driver 44 is employed in this embodiment and shown in FIG. 1.

It may be beneficial to place the visual indicator near the speech reception microphone, to draw the user's attention to the location of the microphone. This is done in this embodiment, as shown schematically in FIG. 1 where the microphone 41 and indicator 45 are located alongside each other in the field of view of the user 1.

Alternatively or additionally, an audio indicator may be used. This has the advantage that the user will notice it without having to see it. For example, a characteristic warning sound could be played intermittently. If the device already has audio output, the indication could be added to the audio output signal.

One approach is for the audio indication to be implemented by artificially modifying the quality of the device's audio output, to reflect the received speech quality. This is particularly appropriate when the user is conducting a speech dialogue with (or via) the device. If a user hears poor quality speech output from the device, he/she will often subconsciously assume that the quality of his/her own speech, as received by the device, is similarly poor. The user will then react by trying to improve the quality of his/her speech.

Thus, when using this approach, if the device's input speech has low SNR, artificial noise is added to its output speech, to encourage the speaker to make an adjustment that raises his/her received speech SNR. If the input speech is too quiet, then the output speech is made quieter (or if too low, made louder). If the input speech is distorted, the output speech can be further distorted.

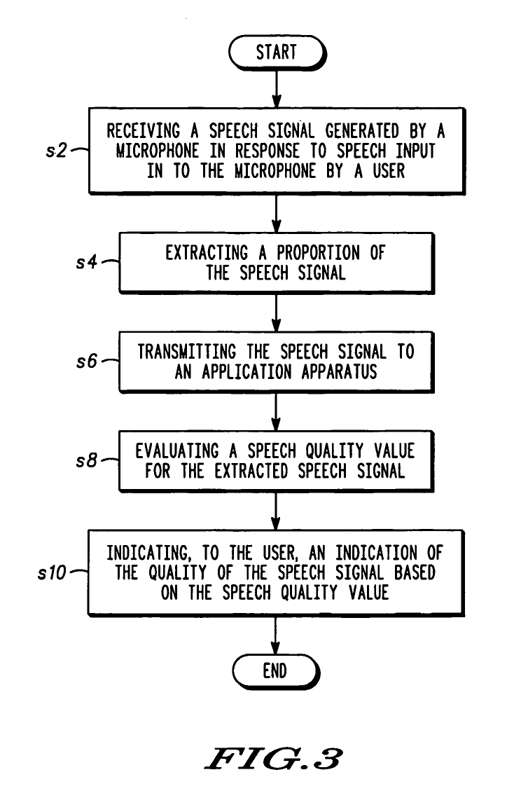

In the above embodiment, the voice communications device 4 included the microphone 41. In other embodiments, the voice communications device may not include the microphone as such, and is instead arranged to receive input from an external microphone. This is the case for a further embodiment shown in FIG. 2.

In the first embodiment described above, a proportion of the speech signal was extracted, for passing to the speech quality evaluator, after it had been processed by the speech processor 42. In other embodiments, this may be extracted at other locations. In particular, as already mentioned earlier, the earlier in the signal chain it is extracted, the more likely it is that the user can improve the indicated quality level by controlling how he inputs the speech in to the microphone. Thus, in other embodiments, a proportion of the speech signal is extracted at a point or location along the signal chain such that the extracted speech signal is in the form generated by the microphone. This is the case in the embodiment shown in FIG. 2, where the extraction point is directly from the microphone output (i.e. before the speech processor 42).

Other details of the embodiment shown in FIG. 2 are the same as the first embodiment.

In the above embodiments, the output speech signal 5 is transmitted to the remaining parts of an application apparatus that is integral with the voice communications device 4. In the above embodiments the application apparatus is a telephone with a speakerphone facility. However, in other embodiments the application apparatus may be, inter alia, any of the following: a telephone with a remote microphone allowing hands-free operation; a mobile telephone with a remote microphone allowing hands-free operation; an automatic speech recognition apparatus; or a computer provided with automatic speech recognition means.

In yet further embodiments, the output speech signal 5 is transmitted to a separate application apparatus (i.e. end-use device) that is remote from the voice communications device. This may be for example, over a dedicated transmission link. In this case the speech processor 42 implements additional processing of the speech signal to render it suitable for such transmission. The remote device may be part of a distributed speech recognition system.

For the above embodiments, a process has been described for processing speech. This process can be summarised in terms of process steps shown in a flowchart in FIG. 3, the process comprising:

receiving a speech signal generated by a microphone in response to speech input in to the microphone by a user (at step s2);

extracting a proportion of the speech signal (at step s4);

transmitting the speech signal to an application apparatus (at step s6);

evaluating a speech quality value for the extracted speech signal (at step s8); and

indicating, to the user, an indication of the quality of the speech signal based on the speech quality value (at step s10).

In the above embodiments, the described modules and functions are implemented in the form of a combination of hardware (circuitry) and software (program instructions and data for one or more processors). The processor(s) may be specifically provided for the quality indication process described.

Alternatively, in the embodiments where the voice communications device 4 is integral with the application apparatus, the processing function may be provided by adapting a conventional processor used by the application apparatus, for general operational control. In each case, implementation may be by means of processor-implementable steps and/or data, e.g. a program, stored in a storage medium, such as PROM or computer disk, for controlling the processor(s).

In summary, a voice communications device has been provided comprising: means for receiving a speech signal generated by a microphone in response to speech input in to the microphone by a user; means for extracting a proportion of the speech signal; means for transmitting

the speech signal to an application apparatus; means for evaluating a speech quality value for the extracted speech signal; and means for indicating, to the user, an indication of the quality of the speech signal based on the speech quality value.

Furthermore, a method of processing speech has been provided comprising: receiving a speech signal generated by a microphone in response to speech input in to the microphone by a user; extracting a proportion of the speech signal; transmitting the speech signal to an application apparatus; evaluating a speech quality value for the extracted speech signal; and indicating, to the user, an indication of the quality of the speech signal based on the speech quality value.

A user may use the invention to make decisions about improving their speech quality, or making adjustments to the acoustic environment or speech reception system, during an on-going conversation. The end user device may be a mobile phone, a portable—or mobile radio (PMR), or a personal digital assistant or lap-top computer with a communication link.

In addition, a storage medium that stores processor-implementable instructions has been provided for controlling one or more processors to carry out the aforementioned method.

It will be understood that the embodiments described above tend to provide a direct indication of the current quality of a received speech signal, in a form that is easily interpreted by a non-expert user of the device, thereby providing the user with an opportunity to improve the speech quality.

1. A voice communications device (4) comprising:
means for receiving a speech signal generated by a microphone (41) in response to speech (2) input in to the microphone (41) by a user;
means for transmitting the speech signal to an application apparatus;
means for extracting a proportion of the speech signal;
means (43) for evaluating a speech quality value for the extracted speech signal;
means (45) for indicating, to the user, an indication of the quality of the speech signal currently received, based on the speech quality value, whereby a user can improve the indicated quality level by controlling in real time, and during an ongoing conversation, how the said user inputs the speech into the microphone;
the said means (45) for indicating being located within the said voice communications device (4).

2. A voice communications device according to claim 1, further comprising a microphone (41) for generating the speech signal.

3. A voice communications device according to claim 1 or 2, wherein a voice communications device and the application apparatus are integral.

4. A voice communications device according to claim 1 or 2, wherein the means for transmitting the speech signal to an application apparatus is adapted to transmit the speech signal to an application apparatus that is remote from the voice communications device.

5. A voice communications device according to any preceding claim, wherein the means for extracting a proportion of the speech signal is located such that the quality of the speech signal at the point of extraction is substantially controllable by the user adjusting his/her inputting of speech in to the microphone (41).

6. A voice communications device according to claim 5, wherein the means for extracting a proportion of the speech signal is located such that the extracted speech signal is in the form generated by the microphone (41).

7. A voice communications device according to any preceding claim, wherein the speech quality value is one of the following group:
(i) speech signal level;
(ii) speech signal to noise ratio.

8. A voice communications device according to any of claims 2 to 7, wherein the means (45) for indicating the quality of the speech signal is located near the microphone (41).

9. A voice communications device according to any preceding claim, wherein the means (45) for indicating the quality of the speech signal is adapted to indicate discrete quality levels.

10. A voice communications device according to claim 9, wherein the means (45) for indicating the quality of the speech signal is adapted to indicate a warning indication when the quality of the speech signal is below an acceptable threshold level.

11. A voice communications device according to any preceding claim, wherein the means (45) for indicating the quality of the speech signal comprises visual indication means.

12. A voice communications device according to claim 11, wherein the visual indication means comprises a colour bargraph display (45).

13. A voice communications device according to any preceding claim, wherein the means for indicating the quality of the speech signal comprises audio indicating means.

14. A voice communications device according to claim 13, wherein the audio indicating means is adapted to modify the quality of an audio output of the application apparatus so that the quality of the audio output of the application apparatus reflects the quality of the speech signal from the user.

15. A voice communications device according to claim 14, wherein the audio indicating means is adapted to modify the quality of an audio output of the application apparatus by one of the following ways:
(i) if the speech signal has low signal to noise ratio, adding artificial noise to the audio output;
(ii) if the volume of the speech signal is too low, reducing the volume of the audio output;
(iii) if the volume of the speech signal is too high, increasing the volume of the audio output; and
(iv) if the speech signal is distorted, distorting the audio output.

16. A voice communications device according to any preceding claim, adapted for use with an application apparatus comprising one of the following group:
(i) a telephone with a speakerphone facility;
(ii) a telephone with a remote microphone allowing hands-free operation;
(iii) a mobile telephone with a remote microphone allowing hands-free operation;
(iv) an automatic speech recognition apparatus; and
(v) a computer provided with automatic speech recognition means.

17. A method of processing speech, comprising:
receiving a speech signal generated by a microphone (41) in response to speech input in to the microphone (41) by a user; and
transmitting the speech signal to an application apparatus;
extracting a proportion of the speech signal;
evaluating a speech quality value for the extracted speech signal; and
indicating, to the user, an indication of the quality of the speech signal currently received based on the speech quality value, whereby the user can improve the indicated quality level by controlling in real time, and during an ongoing conversation, how the said user inputs the speech into the microphone.

18. A method according to claim 17, further comprising generating the speech signal using a microphone (41).

19. A method according to claim 17 or 18, wherein the step of transmitting the speech signal to an application apparatus comprises transmitting the speech signal to an application apparatus that is remote from the voice communications device.

20. A method according to any of claims 17 to 19, wherein the proportion of the speech signal is extracted at a location such that the quality of the speech signal at the point of extraction is substantially controllable by the user adjusting his inputting of speech in to the microphone (41).

21. A method according to claim 20, wherein the proportion of the speech signal is extracted at a location such that the extracted speech signal is in the form generated by the microphone (41).

22. A method according to any of claims 17 to 21, wherein the speech quality value is one of the following group:
(i) speech signal level;
(ii) speech signal to noise ratio.

23. A method according to any of claims 17 to 22, wherein the quality of the speech signal is indicated using indicating means (45) located near the microphone (41).

24. A method according to any of claims 17 to 23, wherein the quality of the speech signal is indicated by discrete quality levels.

25. A method according to claim 24, wherein the quality of the speech signal is indicated by a warning indication when the quality of the speech signal is below an acceptable threshold level.

26. A method according to any of claims 17 to 25, wherein the quality of the speech signal is indicated using visual indication means (45).

27. A method according to claim 26, wherein the visual indication means comprises a colour bargraph display (45).

28. A method according to any of claims 17 to 27, wherein the quality of the speech signal is indicated using audio indicating means.

29. A method according to claim 28, wherein the quality of the speech signal is indicated by modifying the quality of an audio output of the application apparatus so that the quality of the audio output of the application apparatus reflects the quality of the speech signal from the user.

30. A method according to claim 29, wherein the quality of the audio output of the application apparatus is modified by one of the following processes:
(i) if the speech signal has low signal to noise ratio, adding artificial noise to the audio output;
(ii) if the volume of the speech signal is too low, reducing the volume of the audio output;
(iii) if the volume of the speech signal is too high, increasing the volume of the audio output; and
(iv) if the speech signal is distorted, distorting the audio output.

31. A method according to any of claims 17 to 30, used with an application apparatus comprising one of the following group:
(i) a telephone with a speakerphone facility;
(ii) a telephone with a remote microphone allowing hands-free operation;
(iii) a mobile telephone with a remote microphone allowing hands-free operation;
(iv) an automatic speech recognition apparatus; and
(v) a computer provided with automatic speech recognition means.

32. A storage medium storing processor-implementable instructions for controlling one or more processors to carry out the method of any of claims 17 to 31.
